(19) United States
(12) Patent Application Publication
(10) Pub. No.: US 2025/0211305 A1
(43) Pub. Date: Jun. 26, 2025

(54) CHANNEL PROPERTY REPORTING CONFIGURATIONS FOR NON-TERRESTRIAL NETWORKS (NTNS)

(71) Applicant: LENOVO (SINGAPORE) PTE LIMITED, SINGAPORE (SG)

(72) Inventors: Sher Ali CHEEMA, llmenau (DE); Seyedomid TAGHIZADEH MOTLAGH, Oberursel (DE); Majid GHANBARINEJAD, Chicago, IL (US); Ali Ramadan ALI, Kraiburg am Inn (DE)

(21) Appl. No.: 18/848,062

(22) PCT Filed: Mar. 16, 2023
(86) PCT No.: PCT/US2023/064574

§ 371 Date: Sep. 17, 2024

Related U.S. Application Data
(60) Provisional application No. 63/321,491, filed on Mar. 18, 2022.

(51) Int. Cl. H04B 7/06; H04B 7/185; H04W 72/21

(52) U.S. Cl. CPC H04B 7/0626; H04B 7/18513; H04W 72/21

(57) ABSTRACT

Various aspects of the present disclosure relate to configuring and/or enhancing the reporting of channel state information (CSI) and other channel properties to apply prediction models or other prediction techniques for a network, such as at one or more associated UEs and/or at the network. The updated reporting may enable the network to perform and report predictive outputs for CSI quantities of a network, such as an NTN that has inherent channel aging during do the movement of satellites and/or communications delays between UEs and the network, among other benefits.

### CROSS REFERENCE TO RELATED APPLICATIONS

This application claims priority to U.S. Provisional Patent Application No. 63/321,491, filed on Mar. 18, 2022, entitled CHANNEL PROPERTY REPORTING CONFIGURATIONS FOR NON-TERRESTRIAL NETWORKS (NTNs), which is hereby incorporated by reference in its entirety.

### TECHNICAL FIELD

The present disclosure relates to wireless communications, and more specifically to configuring user equipment reporting to provide channel property predictions in non-terrestrial networks.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

In non-terrestrial networks (NTNs), satellites and other flying objects or vehicles provide a communication network or wireless communications system. These NTN wireless communications systems include geostationary satellite (GEO) systems, low earth orbit (LEO) systems, or other satellite-based or moving objects, unmanned aerial vehicles (UAVs), high altitude platform systems (HAPS), and/or other air-to ground networks or flying objects. These systems are typically deployed above the earth, at distances from a few hundred meters above the ground (e.g., in the case of UAVs or drones) to hundreds of kilometers or higher (e.g., in the case of GEO communication networks).

### SUMMARY

The present disclosure relates to methods, apparatuses, and systems that support configuring and/or enhancing the reporting of channel state information (CSI) and other channel properties to apply prediction models or other prediction techniques for a network, such as at one or more associated UEs and/or at the network. The updated reporting may enable the network to perform and report predictive outputs for CSI quantities of a network, such as an NTN that has inherent channel aging during do the movement of satellites and/or communications delays between UEs and the network, among other benefits.

Some implementations of the method and apparatuses described herein may further include receiving configuration instructions from a base station of a non-terrestrial network, where the configuration instructions include: a request to perform a prediction of at least one channel state information (CSI) quantity for CSI aging compensation and a reporting format for reporting an output of the prediction of the at least one CSI quantity, and transmitting a report to the base station that includes the prediction output of the at least one CSI quantity by using the reporting format included in the configuration instructions.

In some implementations of the method and apparatuses described herein, the configuration instructions cause the apparatus to update a reporting information element to include a new parameter that enables reporting of the output of the prediction.

In some implementations of the method and apparatuses described herein, the reporting format includes aperiodic reporting using a Physical Uplink Shared Channel (PUSCH), periodic reporting using a Physical Uplink Control Channel (PUSCH), or semi-persistent reporting using the PUCCH or the PUSCH.

In some implementations of the method and apparatuses described herein, the configuration instructions include a request to report the predicted output of a channel quality indicator (CQI) value at a wideband level or one or more sub-band levels.

In some implementations of the method and apparatuses described herein, the configuration instructions include a request to report the predicted output of a Pre-coding Matrix Indicator (PMI) value at a wideband level or one or more sub-band levels.

In some implementations of the method and apparatuses described herein, the configuration instructions include a request to report, for one or more quantities of channel state information (CSI) of the non-terrestrial network, a calculated value for each CSI quantity and an offset value that indicates a difference between a predicted value for the CSI quantity and the calculated value for the CSI quantity.

In some implementations of the method and apparatuses described herein, the configuration instructions include a request to report, for one or more quantities of channel state information (CSI) of the non-terrestrial network, a calculated value for each CSI quantity and a predicted value for each CSI quantity.

In some implementations of the method and apparatuses described herein, the configuration instructions are received by the apparatus via radio resource control (RRC) signaling between the apparatus and the base station and include a request to perform a prediction specific for at least one CSI quantity.

In some implementations of the method and apparatuses described herein, the configuration instructions are received by the apparatus via Downlink Control Information (DCI) transmitted from the base station to the apparatus and include a request to perform a prediction specific for at least one CSI quantity.

In some implementations of the method and apparatuses described herein, the processor generates the report to include a single report setting that is associated with reporting predicted values for quantities of CSI of the non-terrestrial network for multiple CSI resource settings.

In some implementations of the method and apparatuses described herein, the report includes a single report setting that is associated with reporting predicted values for quantities of CSI for multiple bandwidth partitions (BWPs).

In some implementations of the method and apparatuses described herein, the report includes a single report setting that is associated with reporting predicted polarization values for multiple beams of the non-terrestrial network.

In some implementations of the method and apparatuses described herein, the configuration instructions include a request to report, for one or more quantities of CSI of the non-terrestrial network, values of the quantities of the CSI and a time period for which the values of the quantities of the CSI are to remain valid.

Some implementations of the method and apparatuses described herein may further include transmitting configuration instructions from a network entity to user equipment, where the configuration instructions include a request to perform a prediction for channel properties of the non-terrestrial network over an identified time window, receive, from the user equipment, a report based on the configuration instructions that indicates an output of the performed prediction, and perform a configuration action for one or more resources of the non-terrestrial network using the performed prediction.

In some implementations of the method and apparatuses described herein, the configuration instructions include a request to perform a prediction of signal-to-noise ratio (SNR) changes over the identified time window.

In some implementations of the method and apparatuses described herein, the configuration instructions include a request to report averaged values and multiple values for one or more quantities of CSI of the non-terrestrial network during the identified time window.

In some implementations of the method and apparatuses described herein, the network entity performs a configuration action to apply the output of the performed prediction to the one or more resources of the non-terrestrial network.

In some implementations of the method and apparatuses described herein, the network entity performs a configuration action to apply the output of the performed prediction to reconfigure the one or more resources of the non-terrestrial network.

In some implementations of the method and apparatuses described herein, the configuration instructions include a request to perform a prediction for an averaged value of one or more quantities of CSI of the non-terrestrial network during the identified time window, where the averaged value is based on an average channel during the identified time window or based on averaging predicted values of the one or more quantities of the CSI.

In some implementations of the method and apparatuses described herein, the configuration instructions include a request to include at least one averaged SNR value or one averaged Reference Signal Received Power (RSRP) value for the one or more resources within the identified time window.

In some implementations of the method and apparatuses described herein, the configuration instructions include a request to include multiple SNR values or multiple RSRP values for the one or more resources within the identified time window.

In some implementations of the method and apparatuses described herein, the configuration instructions include a request to include one or more rate of change quantities for the non-terrestrial network over the identified time window, wherein the rate of change quantities include an SNR value, a channel quality indicator (CQI) value, or a Pre-coding Matrix Indicator (PMI) value for the non-terrestrial network.

Some implementations of the method and apparatuses described herein may further include transmitting configuration instructions from a network entity to user equipment that include a request to perform a prediction for channel properties over an identified time window, and performing a configuration action for one or more resources of the non-terrestrial network using a prediction in a report received from the user equipment, where the report is generated in response to the configuration instructions and indicates an output of a performed prediction for the channel properties over an identified time window.

In some implementations of the method and apparatuses described herein, the performed configuration action reconfigures one or more cells of the non-terrestrial network.

In some implementations of the method and apparatuses described herein, the performed configuration action reconfigures one or more BWPs of the non-terrestrial network.

### BRIEF DESCRIPTION OF THE DRAWINGS

FIGS. 1A-1B illustrate examples of wireless communications systems that support channel property reporting configurations for NTNs in accordance with aspects of the present disclosure.

FIG. 2 illustrates an example of a block diagram that supports information exchanges between user equipment and base stations of NTNs in accordance with aspects of the present disclosure.

FIG. 3 illustrates an example of a diagram that presents a report configured to provide channel property predictions to a network in accordance with aspects of the present disclosure.

FIG. 4 illustrates a flowchart of a method that supports network configuration of a user equipment report in accordance with aspects of the present disclosure.

FIGS. 5A-5B illustrate example diagrams that present additional report configurations in accordance with aspects of the present disclosure.

FIG. 6 illustrates an example of a diagram that supports grouping cells in NTNs in accordance with aspects of the present disclosure.

FIG. 7 illustrates a flowchart of a method that supports a network configuring resources using a user equipment report in accordance with aspects of the present disclosure.

FIG. 8 illustrates an example of a block diagram of a device that supports channel property reporting configurations for NTNs in accordance with aspects of the present disclosure.

### DETAILED DESCRIPTION

When compared to terrestrial networks, NTNs often have higher reliability requirements and thus tend to rely more heavily on accurate CSI feedback or other channel quality information from associated user equipment. For example, NTNs can utilize accurate CSI feedback when optimizing network resources provided to the UE (e.g., when the network gateway of a satellite system schedules the optimal cells or other resources of the NTN for the UE).

However, due to the large distances between UEs and the satellites providing the NTNs, certain issues arise that can prevent accurate or useful CSI reporting or feedback from UEs. GEO systems and transparent payload systems are often associated with longer transmission delays (RTDs), and Doppler effects or other movement affects arise within LEO satellite systems. Because of these and other issues (e.g., UE movement, weather or atmospheric conditions) inherent in NTNs, the CSI feedback from a UE can be out-of-date (e.g., or aged), resulting in performance loss, among other drawbacks.

To avoid using outdated CSI feedback and other channel information when optimizing resources of a network, network system can employ prediction-based techniques to attempt to mitigate the effects of channel aging in NTNs when a UE measures CSI for the networks. For example, an NTN can employ Kalmar filtering or various AI/ML (artificial intelligence and/or machine learning) based prediction models, frameworks, and/or techniques when predicting values for CSI quantities or properties of a channel or cell of the NTN.

As described herein, the systems configure and/or enhance reporting of CSI and other channel properties to apply prediction models or other prediction techniques for a network, such as at one or more associated UEs and/or at the network. The updated reporting, in some implementations, enables the network to perform and report predictive outputs for CSI quantities of a network, such as an NTN that has inherent channel aging during do the movement of satellites and/or communications delays between UEs and the network, among other benefits.

For example, the systems can enable/disable configurations for prediction-based output by a UE for one or more quantities, can configure UE reporting to define the quantities to be predicted, can configure UE reporting to provide predictive output for multiple cells/BWPs via a single report, can configure UE reporting to provide multiple predictive outputs for one or more quantities in a single report, and/or can configure UE reporting to include channel assistance information, such as rate of change information for one or more CSI quantities, averaged channel information, average quantities, and so on.

Aspects of the present disclosure are described in the context of a wireless communications system. Aspects of the present disclosure are further illustrated and described with reference to the following device diagrams and flowcharts that relate to predicting channel aging compensation quantities for NTNs

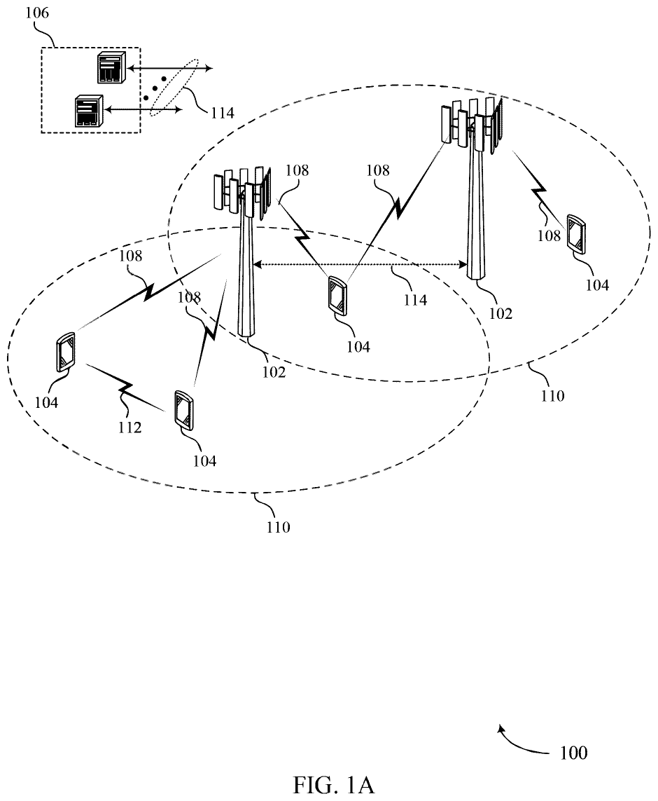

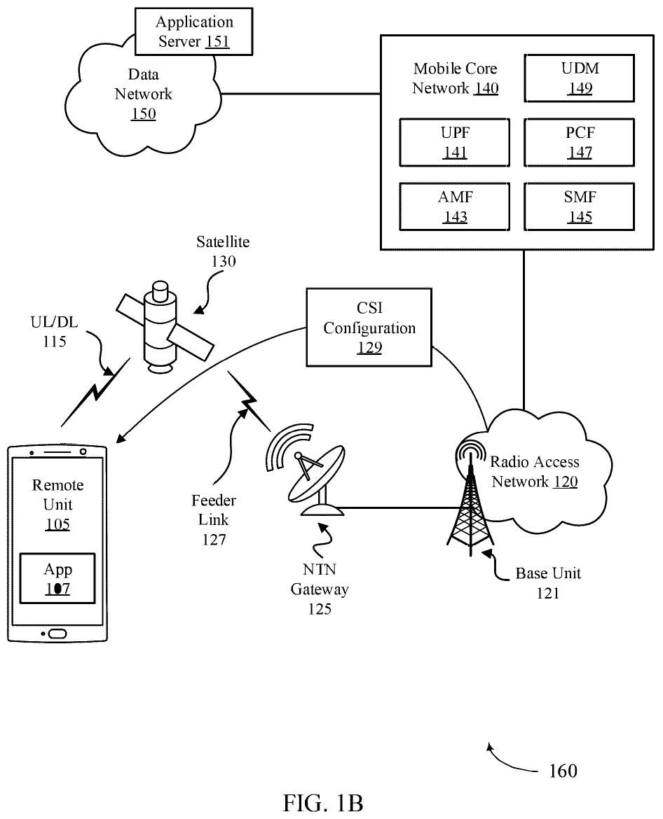

FIG. 1A illustrates an example of a wireless communications system 100 that supports configuring user equipment reporting to provide channel property predictions for NTNs in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wirelessly communicate over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

FIG. 1B illustrates an example of another wireless communications system 160 that supports channel property reporting configurations for NTNs in accordance with aspects of the present disclosure. The wireless communication system 160 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates via a satellite 130 using wireless communication links 123. As depicted, the mobile communication network includes an “on-ground” base unit 121 which serves the remote unit 105 via satellite access.

In some implementations, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In other implementations, the RAN 120 is compliant with the LTE system specified in the 3GPP specifications. More generally, however, the wireless communication system 160 may implement some other open or proprietary communication network, for example Worldwide Interoperability for Microwave Access (“WiMAX”) or IEEE 802.16-family standards, among other networks.

In some embodiments, the remote units 105 are the user equipment 104 of FIG. 1A and can be referred to as mobile devices or user device. The remote units 105 may communicate directly with one or more of the base units 121 in the RAN 120 via uplink (“UL”) and downlink (“DL”) communication signals. The remote units 105 can communicate in a non-terrestrial network via UL and DL communication signals between the remote unit 105 and a satellite 130.

The satellite 130 may communicate with the RAN 120 via an NTN gateway 125 using UL and DL communication signals between the satellite 130 and the NTN gateway 125. The NTN gateway 125 may communicate directly with the base units 121 in the RAN 120 via UL and DL communication signals. Furthermore, the UL and DL communication signals may be carried over the wireless communication links 123. Here, the RAN 120 is an intermediate network that provides the remote units 105 with access to the mobile core network 140. Moreover, the satellite 130 provides a non-terrestrial network allowing the remote unit 105 to access the mobile core network 140 via satellite access.

While FIG. 1B depicts a transparent NTN system where the satellite 130 repeats the waveform signal for the base unit 121, in other embodiments the satellite 130 (e.g., for a regenerative NTN system), or the NTN gateway 125 (e.g., for an alternative implementation of a transparent NTN system) may also act as base station, depending on the deployed configuration.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QOS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120. Note that in the NTN scenario certain RAN entities or functions may be incorporated into the satellite 130. For example, the satellite 130 may be an embodiment of a Non-Terrestrial base station/base unit.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In various implementations, the remote unit 105 receives a CSI configuration 129 from the base unit 121, for measurement and reporting of CSI-RS signals. As described in greater detail below, the CSI configuration 129 may contain a mapping table for dynamic adaptions of the CSI measurement behavior, where the remote unit 105 adjusts its frequency/rate of measurement (i.e., measurement periodicity) and/or its frequency/rate of reporting (i.e., reporting periodicity) based on location and/or signal measurement value.

In some implementations, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”, also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various implementations, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the Fifth Generation Core network (“5GC”). When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various implementations, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain implementations, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIGS. 1A-1B depict components of a 5G RAN and a 5G core network, the described technology applies to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for dynamically adapting a measurement behavior.

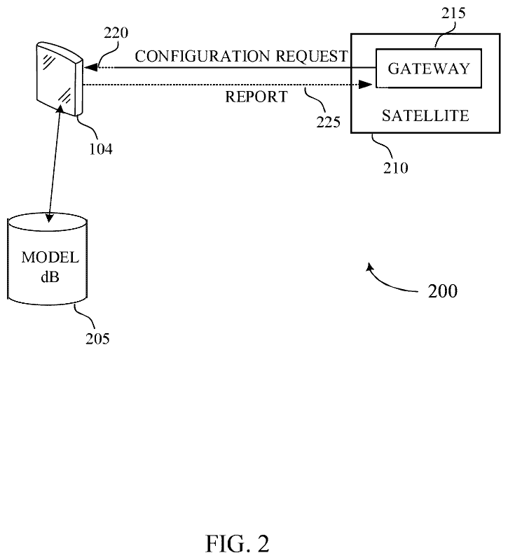

As described herein, the base station 102 or network gateway can be moveable, such as when part of a satellite or flying object associated with a non-terrestrial network (NTN). FIG. 2 illustrates an example of a block diagram that supports information exchanges between user equipment and network gateways of NTNs in accordance with aspects of the present disclosure. These information exchanges can facilitate the configuration of reports generated by the UE 104, such as reports that include, or are updated to include, predicted outputs for various NTN channel quantities, such as CSI quantities.

A satellite 210 includes a network gateway 215, such as a gNB, and provides a non-terrestrial network (NTN) to one or more UEs 104. In some implementations, the satellite 210 is part of a GEO system, a LEO system, or other satellite-based or moving object (e.g., a UAV) systems that provide communication services.

The UE 104 can select a prediction model from a database 205, such as a database that includes AI/ML based prediction models and/or other models (e.g., Kalmar filtering). The UE 104 can receive a configuration request 220 from the network gateway 215, such as a request to update and/or modify generated reports 225 to include different predictions and/or predictive output data. Thus, the network, via the network gateway 215, can configure the UE 104 to apply certain predictions for one or more quantities of one or more network resources associated with one or more BWPs or cells of the network.

In some implementations, the reporting format for the CSI quantities can include aperiodic reporting using PUSCH, PUSCH, and/or semi-persistent reporting using the PUCCH or the PUSCH.

The network, in some cases, configures the UE 104 reporting to include a new parameter within a CSI-ReportConfig section of a report to enable or disable predictive outputs by the UE 104 (e.g., denoted “predictiveoutput”). For example, when the UE 104 is configured with a CSI-ReportConfig with the higher layer parameter set to “enabled,” the UE 104 reports a predictive output quantity. However, when the UE 104 is configured with a CSI-ReportConfig with the higher layer parameter set to “disabled,” the UE 104 does not report the predictive output quantity (but can still report actual quantities based on the actual channel measurements).

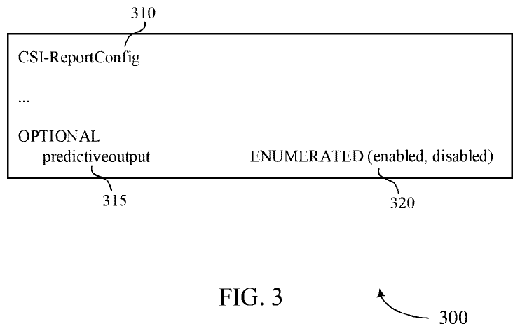

FIG. 3 illustrates an example of a diagram that presents a report configured to provide channel property predictions to a network in accordance with aspects of the present disclosure. The diagram includes an example information element 300 that is part of the UE 104 reporting, such as a section or portion of a report transmitted to the network.

The information element 300 depicts a modified CSI-ReportConfig section, where a higher layer parameter 315, named predictiveoutput, is set to enabled or disabled 320, depending on instructions received from the network. The following provides additional details, including additional parameters, of an example CSI-ReportConfig section:

-- ASN1START
-- TAG-CSI-REPORTCONFIG-START

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| puuch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl40, sl80, sl160, sl320}, |
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF INTEGER(0..32) |

```
    }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL |

-- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

```
    } OPTIONAL -- Need S
  }
OPTIONAL, -- Need R
```

| predictiveoutput | ENUMERATED {enabled, disabled} | |
|---|---|---|
| | | OPTIONAL, -- Need R |
| timeRestrictionForChannelMeasurements | ENUMERATED {configured, notConfigured}, | |
| timeRestrictionForInterferenceMeasurements | ENUMERATED {configured, notConfigured}, | |
| codebookConfig | CodebookConfig | ... |

-- TAG-CSI-REPORTCONFIG-STOP
-- ASN1STOP

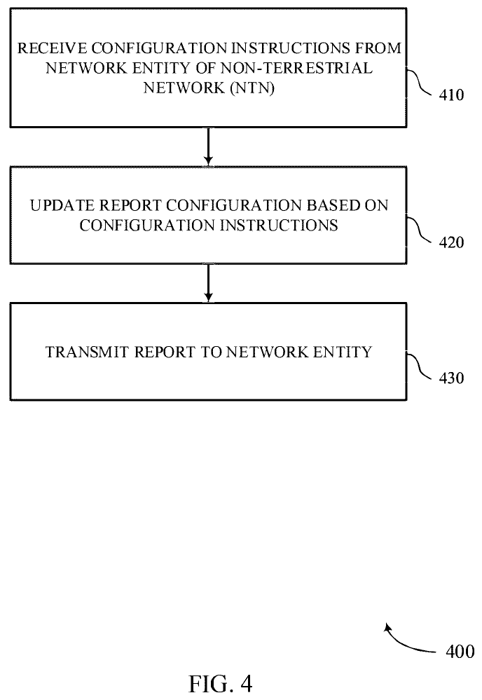

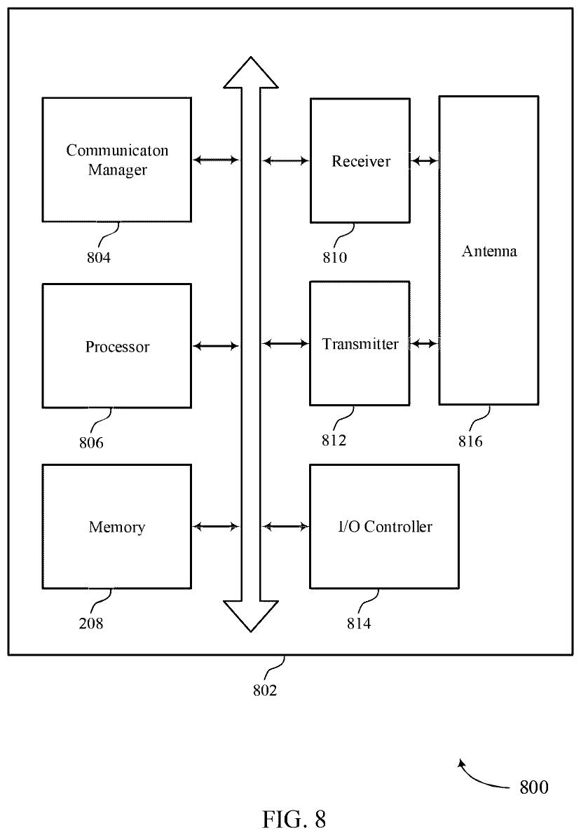

FIG. 4 illustrates a flowchart of a method 400 that supports network configuration of a user equipment report in accordance with aspects of the present disclosure. The operations of the method 400 may be implemented by a device or its components as described herein. For example, the operations of the method 400 may be performed by the user equipment 104 as described with reference to FIG. 8. In some implementations, the device may execute a set of instructions to control the function elements of the device to perform the described functions. Additionally, or alternatively, the device may perform aspects of the described functions using special-purpose hardware.

At operation 410, the method may include receiving configuration instructions from a network entity of a non-terrestrial network (NTN), such as the network gateway 215 of the satellite 210. The configuration instructions can include a request to perform a prediction for at least one CSI quantity for CSI aging compensation and/or a reporting format for reporting an output of the prediction of the at least one CSI quantity. The operations of step 410 may be performed in accordance with examples as described herein. In some implementations, aspects of the operations of step 410 may be performed by a device as described with reference to FIG. 1.

At operation 420, the method may include updating a report configuration based on the received configuration instructions. The operations of step 420 may be performed in accordance with examples as described herein. In some implementations, aspects of the operations of step 420 may be performed by a device as described with reference to FIG. 1.

At operation 430, the method may include transmitting the updated report to the network entity. The operations of step 430 may be performed in accordance with examples as described herein. In some implementations, aspects of the operations of step 430 may be performed by a device as described with reference to FIG. 1.

In some implementations, the network configures the UE 104 to apply prediction either on a wideband level of network or on subband levels of the network (e.g., via parameters within the CSI-ReportConfig information element). Based on the higher layer configuration, the UE 104 can report an actual measurement of a quantity and/or a prediction of the quantity. Further, the information element 300 can include a reportFreqConfiguration value or parameter, which indicates the frequency granularity of the CSI Report for some or all of the quantities (see Appendix A).

For example, the UE 104 configures wideband CQI or subband CQI reporting by the higher layer parameter cqi-FormatIndicator. When wideband CQI reporting is configured and predictive output is also configured either through higher layer parameter signaling (e.g., “predictiveoutput” in CSI-ReportConfig) or dynamically triggered through DCI or though MAC CE (Medium Access Control Element), the UE 104 reports wideband CQI and/or corresponding predicted wideband CQI for each codeword for the entire CSI reporting band. When subband CQI reporting is configured and predictive output is also configured either through higher layer parameter signaling (e.g., “predictiveoutput” in CSI-ReportConfig) or dynamically triggered through DCI or though MAC CE, the UE 104 reports CQI with and/or without prediction for each codeword for each subband in the CSI reporting band. See Appendix A.

As another example, the UE 104 configures wideband PMI or subband PMI reporting by the higher layer parameter pmi-FormatIndicator. When wideband PMI reporting is configured and predictive output is also configured either through higher layer parameter signaling (e.g., “predictiveoutput” in CSI-ReportConfig) or dynamically triggered through DCI or though MAC CE, the UE 104 reports a wideband PMI and/or corresponding predicted wideband PMI for the entire CSI reporting band. When subband PMI reporting is configured and predictive output is also configured either through higher layer parameter signaling (e.g., “predictiveoutput” in CSI-ReportConfig) or dynamically triggered through DCI or though MAC CE, except with 2 antenna ports, the UE 104 reports a single wideband indication and/or predictive output for the entire CSI reporting band and reports one subband indication for each subband in the CSI reporting band. When subband PMIs are configured with 2 antenna ports, the UE 104 reports PMI with and/or without prediction for each subband in the CSI reporting band. See Appendix A.

In some cases, the UE 104 can report various combination of actual and/or predicted values for CSI. For example, the UE 104 can report two values, such as the actual value and the predicted value. However, as another example, the UE 104 can report the values in relation to one another. For example, the UE 104 can report the actual value (e.g., a calculated value) and an offset value or indicator that represents a difference between the actual value and the predicted value.

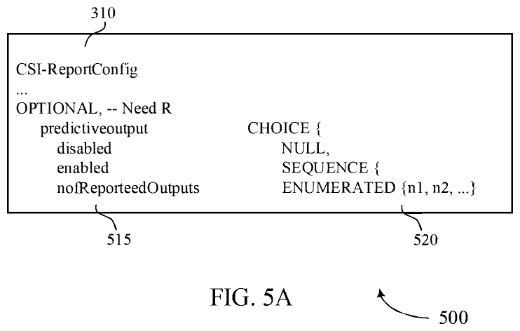

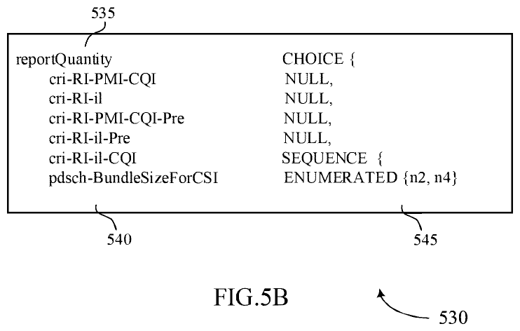

The network, therefore, can configure the UE 104 to report actual quantities and same quantities in the same report. FIG. 5A illustrates an information element 500 of the CSI-ReportConfig reporting 310, where a higher layer parameter 515 (e.g., predictiveoutput) is set to “enabled,” 520 and an additional parameter (e.g., “nrofReportedOutputs”) is set to a requested number of outputs (e.g., as shown, reporting both the actual quantity and the predictive quantity).

In some implementations, the network configures the UE 104 by indicating a quantity to be predicted. The network can transmit configuration instructions via radio resource control (RRC) signaling between the UE 104 and the gNB 214 (e.g., in CSI-ReportConfig or a new configuration) and/or via MAC CE or via Downlink Control Information (DCI), such as via a new field in DCI 1_0.

For example, the network configures the CSI-ReportConfig for the UE 104 with the higher layer parameter reportQuantity set to a value to indicate quantities to receive prediction-based output. In some cases, by default all quantities configured by the higher layer parameter reportQuantity can receive a prediction-based output (e.g., when configured to report predictive output by some higher layer parameter or low-level signaling). In some cases, when the UE 104 is configured with a CSI-ReportConfig with the higher layer parameter reportQuantity set to “all,” The UE 104 reports prediction-based output for all quantities for the CSI-ReportConfig.

In some implementations, the network can configure the UE 104 to report prediction-based values for specific or identified quantities. For example, the network can configure the CSI-ReportConfig of the UE 104 with the higher layer parameter reportQuantity set to a value such as “cri-RI-PMI-CQI-Prei,” “cri-RI-CQI-Prei,” and/or “cri-RI-LI-PMI-CQI-Prei,” where the abbreviation Prei (prediction) represents a prediction-based output only for the specified quantities to be reported by the UE 104.

FIG. 5B illustrates an information element 550 of the CSI-ReportConfig reporting 310, where a higher layer parameter reportQuantity 535 is set to “cri-RI-PMI-CQI-Pre” or “cri-RI-LI-PMI-CQI-Pre” 540. As set, the UE 104 reports a preferred prediction based on a precoder matrix for the entire reporting band, or a preferred precoder matrix per subband, depending on higher layer parameter pmi-FormatIndicator 545. Alternatively, the UE 104 can configure an index corresponding to the quantities by a separate parameter within the higher layer parameter reportQuantity 535 to indicate which quantity or quantities are to receive prediction-based output.

In some implementations, the network can configure the UE 104 to include, in a single report, predictions for multiple quantities or resource settings, such as quantities/settings that share a common bandwidth partition identifier (BWP-id). For example, in non-terrestrial networks, a frequency reuse factor of 3 or 4 is common (and also supported in the 3GPP framework) to improve link budget by mitigating inter-beam/cell interference.

One way to achieve a frequency reuse factor greater than 1 is to employ different BWPs for neighboring beams. To accurately predict a next beam ID or CQI associated with a common or different BWP, the UE 104 can include or be configured with multiple resource settings (e.g., in the CSI-ResourceConfig), such as settings that correspond to different BWPs. The higher layer parameter BWP-id can identify each CSI resource setting located in the DL BWP.

These scenarios can be relevant for UEs at beam edges, or, in case of earth moving cells, where beam-level mobility results in an inaccurate/outdated CSI report. In some cases, a single CSI report setting is associated with multiple CSI resource settings (via CSI-ResourceConfig) that can share or not share a common BWP-id. In these cases, the UE 104 reports quantities in the same report with a BWP-id, and when the UE 104 performs predictive outputs, the predictive outputs are also associated with the BWP-id (e.g., a BWP-id followed by the reporting quantities related to that BWP-id would be part of the CSI report).

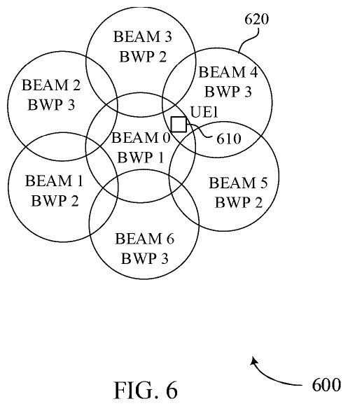

FIG. 6 illustrates an example of a diagram 600 that supports grouping cells in NTNs in accordance with aspects of the present disclosure. The network configures the UE 610 to report estimated and predicted CRI/SSBRI values based on CSI resource settings for different BWPs 620. The UE 610 calculates the CRI/SSBRI values for the current channel conditions and predicts the next CRI/SSBRI values based on the already configured satellite input parameters.

Because the UE 610 is on the cell edge and beam 0 may not be valid due to beam mobility or satellite mobility, the UE 610, via its reporting, includes the predicted CRI corresponding to beam 4 in the same report, but with different a BWP-id. Further, the UE 610 can include, along with the CRI/SSBRI values, predictions for the type of polarization (e.g., linear, left-hand circular polarization, right-hand circular polarization) of the cells/beams. In some cases, the UE 610 sends a single CSI report includes wideband or subband CQI/PMI predictive values corresponding to different BWP-Ids. For example, a BWP-id can indicate the predictive values correspond to the BWP-id.

In some cases, the network can configure the UE 104 to indicate time or duration information, such as information that indicates a length of time for which certain reported quantities are to be considered valid. The UE 104, configured by the network or acting autonomously, can transmit a single CSI report containing a series of predictive based outputs for one or multiple quantities, along with an indication of a time for which the outputs are valid.

Depending on satellite speed and delays associated with the network gateway 215 and/or the associated NTN, the network can select which predictive quantity is valid and/or most suitable. in some implementations, the reporting of multiple predictive quantities with associated valid time durations implies that the reported quantities are to be applied in a sequential manner. For example, when the UE 104 reports a series of CQI with corresponding time durations, the network applies the first CQI for a first indicated duration and the second CQI for a second indicated duration. In some cases, the sequential application of predictive outputs can assist an NTN with avoiding large signaling overheads where large delays are common, such as in cases of transparent payloads.

In some cases, instead of indicating a series of predictive quantities (e.g., CRI/SSBRI/CQI/PMI), the UE 104 reports offset values corresponding to the first quantity. For example, if the UE 104 indicates a series of CQI values within a report, the first corresponds to a CQI value, the second value indicates the relative offset to the first value, and the third value indicates the relative offset to the first value, and so on. In some cases, the offset values are relative to each other, where the second value is offset to the first value, the third value is offset to the second value, and so on. Similarly, the UE 104 can indicate relative durations as offsets to the first value and/or a preceding value.

In some implementations, the network can implement predictions or aging calculations. To do so, the network requests or utilizes channel statistic related information from one or more UEs, such as the UE 104. For example, the network can request SNR degradation/improvement information over a time window or SNR/RSRP values associated with different beams. Further, the network can utilize information that identifies a rate of change of CQI over a time period and/or averaged channel statistics.

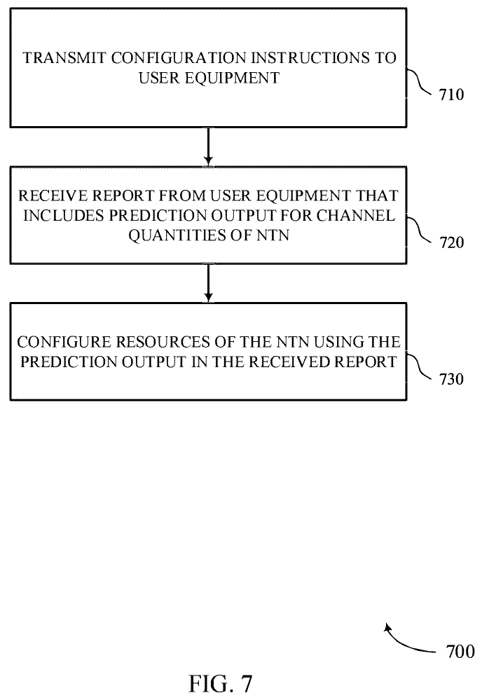

FIG. 7 illustrates a flowchart of a method 400 that supports a network configuring resources using a user equipment report in accordance with aspects of the present disclosure. The operations of the method 700 may be implemented by a device or its components as described herein. For example, the operations of the method 700 may be performed by the base station 102 as described with reference to FIG. 8. In some implementations, the device may execute a set of instructions to control the function elements of the device to perform the described functions. Additionally, or alternatively, the device may perform aspects of the described functions using special-purpose hardware.

At operation 710, the method may include transmitting configuration instructions to user equipment. The operations of step 710 may be performed in accordance with examples as described herein. In some implementations, aspects of the operations of step 710 may be performed by a device as described with reference to FIG. 1.

At operation 720, the method may include receiving a report from the user equipment that includes prediction output for channel quantities of the NTN. The operations of step 720 may be performed in accordance with examples as described herein. In some implementations, aspects of the operations of step 720 may be performed by a device as described with reference to FIG. 1.

At operation 430, the method may include configuring resources of the NTN using the prediction output in the received report. The operations of step 730 may be performed in accordance with examples as described herein. In some implementations, aspects of the operations of step 730 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

In some implementations, the network configures the UE 104 to report one or more quantities (e.g., CQI, PMI, RI) or another quantity, such as channel statistics, over a certain time window, to compensate for aging or outdated channel information. The UE 104 can transmit a report that is based on an averaged value and/or multiple values calculated over a configured time duration. Upon receiving the values, the network can apply prediction or use the quantities for resource configurations.

For example, the network can configure the specific methodology, such as prediction or channel averaging, and/or the AI/ML model for deciding on the suitable averaging of the values. By employing the channel averaging to calculate a desired quantity, the network can resolve or mitigate long-term fading impacts, thus improving the performance losses due to delayed/outdated CSI, among other benefits. In some cases, the time window is based on an associated satellite speed, orbit (e.g., satellite altitude and longitude), and/or type of payload (e.g., transparent payload or regenerative payload) of the NTN.

In some implementations, the network configures a higher layer parameter to configure the time window duration for channel averaging. For example, the network can define a parameter in the CSI-ReportConfig that configures the time duration (e.g., number of slots) over which the channel should be averaged. When configured through RRC, the network can configure an additional indication either through the RRC (or through MAC CE or DCI) to enable/disable the report based on the averaged channel. In some cases, the network can configure the time duration for CSI report through MAC CE or dynamically through DCI.

In some implementations, the network configures the UE 104 with the type of quantities to be estimated based on averaged channel information, as well as the quantities to include in a CSI report. The report can indicate the configuration via a higher layer parameter reportQuantity in CSI-ReportConfig, where an additional parameter indicates specific quantities. For example, quantities to receive channel averaging over a time window would be specifically defined, e.g., “cri-RI-PMI-CQI-ChAi,” “cri-RI-CQI-ChAi,” or “cri-RI-LI-PMI-CQI-ChAi,” where the abbreviation ChA is used as an example to indicate channel averaging. In some cases, the network can configure an index corresponding to a quantity from a predefined table in the CSI-ReportConfig information element. The network can indicate the index through MAC CE or DCI.

In some implementations, the network configures the UE 104 to report an averaged value of a configured quantity over a time duration, where the averaged value is based on an average channel over the time duration or calculating an average of the quantity. For example, when averaging is carried out over an average channel, the UE 104 averages different samples of the channel coefficients over the time window, and, based on the averaged channel coefficients, the UE 104 estimates the quantity (e.g., CQI, RI, PMI, SNR). As another example, when the UE 104 averages the quantities, the UE 104 calculates and averages the configured reporting quantity for all the estimated quantities for each of the channel samples within the time window.

The network, in some cases, can configure the type of averaging via a higher layer parameter, through low level signaling, and/or autonomously based on the output of an applied AI/ML model that considers the instantaneous or the statistical variation of the channel over previous measurements. In some cases, the network configures both types of averaging, and the UE 104 includes in its report what type of averaging was performed for a specific quantity or a group of quantities. In some cases, the UE 104 always includes the type of averaging when reporting predictions for quantities.

In some implementations, the network configures the UE 104 to indicate in a single report an averaged SNR/RSRP value and/or multiple SNR/RSRP values corresponding to same or different CSI resources within the time window, where the multiple SNR/RSRP values corresponds to different time snapshots/samples within the time window. The network can configure the time window or granularity through RRC signaling (e.g., in the CSI-ReportConfig information element) or through MAC CE or DCI. The UE 104, in some cases, includes a time stamp corresponding to each SNR/RSRP value to distinguish between different values and/or provide an indication of the time window for which the value was averaged or predicted. In some cases, the UE 104 sends multiple reports corresponding to each of the CSI resources within the time window, where each report includes one averaged SNR/RSRP value and multiple SNR/RSRP values, and the associated time stamps.

In some implementations, the network configures the UE 104 to report a rate of change of one or more quantities (e.g., SNR, CQI, PMI) over a time duration/window. The rate of change, in some cases, can indicate how a channel is varying over time. Based on the rate of change value, the network can estimate the actual quantity to be used after receiving the report from the UE 104. In such cases, the report can approximate all channel variations in a single value, reducing the signaling burden when reporting to the network.

In some cases, the UE 104 can include a parameter in the CSI-ReportConfig information element that indicates the UE is expected to report a CSI quantity along with its rate of change. The network can configure the parameter through DCI, where a single bit can indicate enable/disable. For example, a 0 value can indicate the rate of change of the quantity calculation is not activated and the 1 value can indicate the rate of change of the quantity calculation is activated and should be applied and reported by the UE 104.

In some cases, the CSI report does not include the rate of change of the configured, and the UE 104 separately reports the rate of change to the network, such as via UCI. In other cases, the UE 104 includes the rate of change approximation as part of a CSI report.

FIG. 8 illustrates an example of a block diagram 800 of a device 802, which supports predicting channel aging compensation quantities for non-terrestrial networks (NTNs) in accordance with aspects of the present disclosure. The device 802 may be an example of the UE 104 (or the base station 102, such as the gNB 215 of the satellite 210), as described herein. The device 802 may support wireless communication with one or more base stations 102, UEs 104, or any combination thereof. The device 802 may include components for bi-directional communications including components for transmitting and receiving communications, such as a communications manager 804, a processor 806, a memory 808, a receiver 810, transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication at a first device (e.g., the device 802) in accordance with examples as disclosed herein. The communications manager 804 may be configured as or otherwise support a means for predicting channel aging compensation quantities for non-terrestrial networks (NTNs), as described herein. For example, the communications manager can: receive configuration instructions from a base station of a non-terrestrial network, where the configuration instructions include a request to perform a prediction of at least one channel state information (CSI) quantity for CSI aging compensation and a reporting format for reporting an output of the prediction of the at least one CSI quantity, and transmit a report to the base station that includes the prediction output of the at least one CSI quantity by using the reporting format included in the configuration instructions.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

In addition to supporting wireless communication at a first device, such as the UE 104, the communications manager 804, when implemented as part of the base station 102, can support wireless communication at a second device (e.g., the device 802) in accordance with examples as disclosed herein. The communications manager 804 may be configured as or otherwise support a means for configuring resources using a user equipment report, as described herein. For example, the communications manager 804 can: transmit configuration instructions from the base station to the user equipment, where the configuration instructions include a request to perform a prediction for channel properties of the non-terrestrial network over an identified time window, receive, from the user equipment, a report based on the configuration instructions that indicates an output of the performed prediction, and perform a configuration action for one or more resources of the non-terrestrial network using the performed prediction.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive configuration instructions from a network entity of a non-terrestrial network,
wherein the configuration instructions include:
a request to perform a prediction of at least one channel state information (CSI) quantity for CSI aging compensation; and
a format for reporting an output of the prediction of the at least one CSI quantity; and
transmit a report to the network entity that includes the prediction output of the at least one CSI quantity by using the format included in the configuration instructions.

2. The UE of claim 1, wherein the configuration instructions cause the UE to update a reporting information element to include a parameter that enables reporting of the output of the prediction.

3. The UE of claim 1, wherein the format includes aperiodic reporting using a Physical Uplink Shared Channel (PUSCH), periodic reporting using a Physical Uplink Control Channel (PUSCH), semi-persistent reporting using the PUCCH or the PUSCH, or a combination thereof.

4. The UE of claim 1, wherein the configuration instructions include a request to report the predicted output of a channel quality indicator (CQI) value at a wideband level or one or more sub-band levels.

5. The UE of claim 1, wherein the configuration instructions include a request to report the predicted output of a Pre-coding Matrix Indicator (PMI) value at a wideband level or one or more sub-band levels.

6. The UE of claim 1, wherein the configuration instructions include a request to report, for one or more quantities of CSI, a calculated value for each CSI quantity and an offset value that indicates a difference between a predicted value for the CSI quantity and the calculated value for the CSI quantity.

7. The UE of claim 1, wherein the configuration instructions include a request to report, for one or more quantities of CSI, a calculated value for each CSI quantity and a predicted value for each CSI quantity.

8. The UE of claim 1, wherein the configuration instructions are received by the UE via radio resource control (RRC) signaling and include a request to perform a prediction specific for at least one CSI quantity.

9. The UE of claim 1, wherein the configuration instructions are received by the UE via downlink control information (DCI) and include a request to perform a prediction specific for at least one CSI quantity.

10. The UE of claim 1, wherein the at least one processor is further configured to cause the UE to generate the report to include a single report setting that is associated with reporting predicted values for quantities of CSI of the non-terrestrial network for multiple CSI resource settings.

11. The UE of claim 1, wherein the at least one processor is further configured to cause the UE to generate the report to include a single report setting that is associated with reporting predicted values for quantities of CSI for multiple bandwidth partitions (BWPs).

12. The UE of claim 1, wherein the at least one processor is further configured to cause the UE to generate the report to include a single report setting that is associated with reporting predicted polarization values for multiple beams of the non-terrestrial network.

13. The UE of claim 1, wherein the configuration instructions include a request to report, for one or more quantities of CSI, values of the quantities of the CSI and a time period for which the values of the quantities of the CSI are to remain valid.

14. A method performed by a user equipment (UE), the method comprising:
receiving configuration instructions from a network entity of a non-terrestrial network, wherein the configuration instructions include:
a request to perform a prediction for at least one channel state information (CSI) quantity for CSI aging compensation and
a format for reporting an output of the prediction of the at least one CSI quantity; and
transmitting a report to the network entity that includes the prediction output of the at least one CSI quantity by using the reporting format included in the configuration instructions.

15. A network entity of a non-terrestrial network, the network entity comprising:
at least one memory; and
at least one processor coupled with the at least one memory and configured to cause the network entity to:
transmit configuration instructions to a user equipment (UE),
wherein the configuration instructions include a request to perform a prediction for channel properties of the non-terrestrial network over a time window;
receive, from the UE, a report based on the configuration instructions that indicates an output of the performed prediction; and
perform a configuration action for one or more resources of the non-terrestrial network using the performed prediction.

16. The network entity of claim 15, wherein the configuration instructions include a request to perform a prediction of signal-to-noise ratio (SNR) changes over the identified time window.

17. The network entity of claim 15, wherein the configuration instructions include a request to report averaged values and multiple values for one or more quantities of channel state information (CSI) of the non-terrestrial network during the identified time window.

18. The network entity of claim 15, wherein the network entity performs a configuration action to apply the output of the performed prediction to the one or more resources of the non-terrestrial network.

19. The network entity of claim 15, wherein the network entity performs a configuration action to apply the output of the performed prediction to reconfigure the one or more resources of the non-terrestrial network.

20. (canceled)

21. A processor for wireless communication, comprising:
at least one controller coupled with at least one memory and configured to cause the processor to:
receive configuration instructions from a network entity of a non-terrestrial network,
wherein the configuration instructions include:
a request to perform a prediction of at least one channel state information (CSI) quantity for CSI aging compensation; and
a format for reporting an output of the prediction of the at least one CSI quantity; and
transmit a report to the network entity that includes the prediction output of the at least one CSI quantity by using the reporting format included in the configuration instructions.
